(19) United States
(12) Patent Application Publication
(10) Pub. No.: US 2026/0255079 A1
(43) Pub. Date: Aug. 27, 2026

(54) IMAGE PROCESSING METHOD AND DEVICE

(71) Applicant: Wistron Corporation, New Taipei City (TW)

(72) Inventor: CHU FEI TENG, New Taipei City (TW)

(21) Appl. No.: 19/216,762

(22) Filed: May 23, 2025

(30) Foreign Application Priority Data
Feb. 26, 2025 (TW) 114107060

(51) Int. Cl. H04N 25/57; H04N 23/72; H04N 23/73; H04N 23/741; H04N 23/76; H04N 23/667

(52) U.S. Cl. CPC H04N 25/57; H04N 23/72; H04N 23/73; H04N 23/741; H04N 23/76; H04N 23/667

(57) ABSTRACT

An image processing method is disclosed. The image processing method includes the following steps of: in a preview mode, dividing a preview grayscale image into a plurality of grids and obtaining average grayscales of the plurality of grids respectively; performing inverse compensation on the preview grayscale image; declaring a plurality of regions and dividing the plurality of grids into corresponding regions among the plurality of regions to generate a region information, and generating an exposure map including at least one compensated exposure time based on at least one current exposure time and at least one compensation ratio; and in a shooting mode, exposing using the at least one compensated exposure time to obtain an image based on the region information and the exposure map.

### CROSS-REFERENCE TO RELATED APPLICATION

This application claims priority to and the benefit of Taiwan Application Serial No. 114107060, filed in the Taiwan Intellectual Property Office (TIPO) on Feb. 26, 2025, the entire content of which is incorporated herein by reference as if fully set forth below in its entirety and for all applicable purposes.

### TECHNICAL FIELD

The present disclosure relates to image processing, more particularly, to an image processing method and device.

### BACKGROUND

In general, when the camera takes pictures in a high-contrast scene, the images it captures are prone to overexposure or underexposure. For example, in order to preserve the details in the low-brightness region of the image, the exposure amount of the camera is increased, but the high-brightness region of the image is overexposed and the details are lost at the same time; or in order to preserve the details in the high-brightness region of the image, the exposure amount of the camera is reduced, but the low-brightness region of the image is underexposed and the details are lost at the same time.

In order to solve the above-mentioned problem, image sensors with high dynamic range (HDR) are usually used in the cameras, and the image sensors with HDR may capture multiple frames of images through different exposure times. The multiple frames of images each retain the details of the high brightness region or the low brightness region. Finally, the multiple frames of images are synthesized through an algorithm to simultaneously retain the details of the high brightness region and the low brightness region in the image.

The image sensors with HDR can be mainly divided into two types: parallel-type and sequential-type. The advantage of the parallel-type HDR image sensors is their high speed, which may simultaneously generate multiple frames of images with short, medium and long exposure times. However, their disadvantage is that they need to be used with a specific platform, which may lead to issues with sensor support. The advantage of the sequential-type HDR image sensors is that they rely mainly on software to sequentially generate multiple frames of images with different exposure time lengths without the problem of sensor support. However, their disadvantage is that they are slow, which makes it easy to produce ghost images when shooting moving targets.

Taking a common complementary metal-oxide-semiconductor image sensor (CMOS Image Sensor, CIS) as an example, it usually adopts a rolling shutter to perform frame-based exposure or line-based exposure. The former refers to completing the exposure of a whole frame of image with the same exposure time, while the latter refers to staggered exposure of different rows in the same frame of image with exposure times of different lengths to obtain multiple frames of downscaled images after exposure for different lengths of time.

However, no matter which exposure method is used, the plurality of frames with different exposure time lengths must be obtained to perform the "image synthesis" process, which greatly increases the complexity and workload of the entire image processing flow.

### SUMMARY

In view of this, an image processing method and device are proposed in the present disclosure to effectively solve the above-mentioned problems in the prior art.

An embodiment of the present disclosure is an image processing method. In this embodiment, the image processing method includes: in a preview mode, dividing a preview grayscale image into a plurality of grids and obtaining average grayscales of the plurality of grids respectively; performing an inverse compensation on the preview grayscale image; declaring a plurality of regions and dividing the plurality of grids into corresponding regions among the plurality of regions to generate a region information, and generating an exposure map including at least one compensated exposure time based on at least one current exposure time and at least one compensation ratio; and in a shooting mode, exposing using the at least one compensated exposure time to obtain an image based on the region information and the exposure map.

Another embodiment of the present disclosure is an image processing device. In this embodiment, the image processing device includes a processor and an image sensor array. The processor is configured to: in a preview mode, divide a preview grayscale image into a plurality of grids and obtain average grayscales of the plurality of grids respectively; perform an inverse compensation on the preview grayscale image; declare a plurality of regions and divide the plurality of grids into corresponding regions among the plurality of regions to generate a region information, and generate an exposure map including at least one compensated exposure time based on at least one current exposure time and at least one compensation ratio; and generate a row control signal, a column control signal and a data signal according to the region information and the exposure map. The image sensor array is coupled to the processor and is configured to expose using the at least one compensated exposure time in a shooting mode to obtain an image based on the row control signal, the column control signal and the data signal.

### BRIEF DESCRIPTION OF THE DRAWINGS

FIG. 1 is a schematic diagram showing that the image processing device of the present disclosure may perform single-point exposure in units of pixels.

FIG. 2 is a schematic diagram showing that the image processing device of the present disclosure may control the simultaneous exposure of multiple points in the same region in units of regions.

FIG. 3 is a schematic diagram showing that the image processing device of the present disclosure may expose the entire frame simultaneously.

FIG. 4 is a flow chart of an image processing method according to an embodiment of the present disclosure.

FIGS. 5A to 5D are schematic diagrams respectively illustrating a preview color image, a preview grayscale image divided into a plurality of grids, a downscaled preview grayscale image, and a downscaled preview grayscale image after inverse compensation according to the present disclosure.

FIG. 6 is a schematic diagram showing an exposure map and region information of the present disclosure.

FIG. 7 is a flow chart of an image processing method according to another embodiment of the present disclosure.

FIG. 8 is a schematic diagram showing how the image signal processor of the present disclosure controls a specific region to be exposed through a column control signal, a row control signal and a data signal.

FIG. 9 is a schematic diagram of a CMOS image sensor array according to the present disclosure.

### DETAILED DESCRIPTION

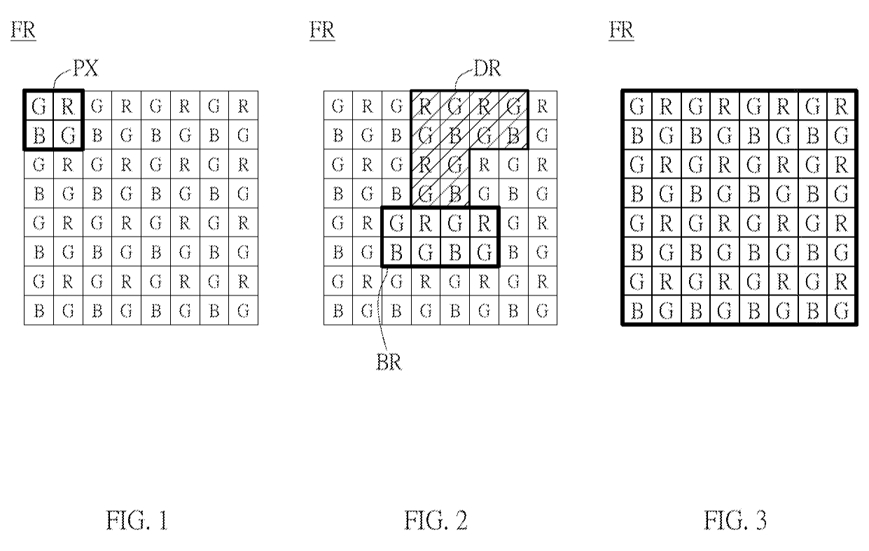

The following describes the implementation methods disclosed in the present disclosure through specific embodiments in conjunction with FIGS. 1 to 9. Those skilled in the art may understand the advantages and effects of the present disclosure from the contents disclosed in this specification. However, the following disclosure is not intended to limit the protection scope of the present disclosure.

A single frame high dynamic range (HDR) technology that performs pixel-based exposure is proposed in the present disclosure. This technology may be applied to an image sensor array, so that each pixel in the image sensor array is an independent unit and has an independent exposure control circuit, thereby allowing algorithm designers to retain maximum design flexibility.

For example, as shown in FIG. 1 , the entire frame FR may be exposed at a single point in units of pixels PX; as shown in FIG. 2, the entire frame FR may be divided into a plurality of regions (such as a high brightness region BR, a shadow region DR, etc.), and the simultaneous exposure of multiple points in the same region may be controlled in units of regions, so as to achieve the simultaneous existence of multiple different exposure time lengths in the same frame FR and obtain an HDR image that simultaneously preserves the details of the bright and dark parts; as shown in FIG. 3, the entire frame FR may also be exposed at the same time, similar to a global shutter.

In an embodiment, when an image processing device (such as a camera) is turned on, its image sensor array will continuously stream the received images, and its processor will divide the image output mode of the camera into different modes such as preview/snapshot/video according to actual needs, and these modes correspond to different resolutions (such as full resolution/1080P/720P/VGA, etc.) and different display frames per second (Frame Per Second, FPS). For example, before the user presses the shooting button of the camera, the camera is operated in preview mode, and the image displays a preview image at a lower resolution (e.g., 1080P).

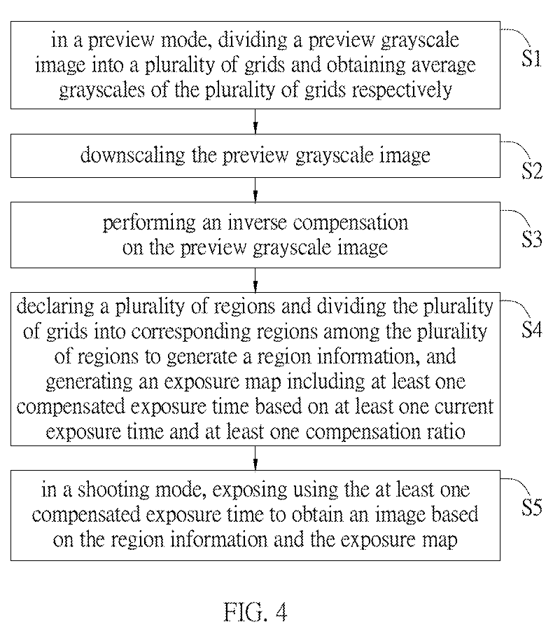

A specific embodiment of the present disclosure is an image processing method. As shown in FIG. 4, the image processing method in the embodiment may include the following steps:

S1: in a preview mode, dividing a preview grayscale image into a plurality of grids and obtaining average grayscales of the plurality of grids respectively;

S2: downscaling the preview grayscale image;

S3: performing an inverse compensation on the preview grayscale image;

S4: declaring a plurality of regions and dividing the plurality of grids into corresponding regions among the plurality of regions to generate a region information, and generating an exposure map including at least one compensated exposure time based on at least one current exposure time and at least one compensation ratio; and

S5: in a shooting mode, exposing using the at least one compensated exposure time to obtain an image based on the region information and the exposure map.

In actual applications, the step S1 may obtain a preview color image in the preview mode and convert the preview color image into a preview grayscale image, but not limited to this; the step S2 may divide the first level (e.g., 256 levels) of the preview grayscale image by a preset ratio (e.g., 32) to reduce its level to a second level (e.g., 8 levels), but not limited to this; the step S3 may use the following inverse compensation method to subtract the maximum value from each level in the second level and take the absolute value, thereby generating a plurality of exposure compensation amounts (e.g., 8 exposure compensation amounts) corresponding to the second level (e.g., 8 levels) , so that the highest level (e.g., the 7th level) in the second level (e.g., 8 levels) corresponds to the lowest exposure compensation amount, and the lowest level (e.g., the 0th level) in the second level (e.g., 8 levels) corresponds to the highest exposure compensation amount, but not limited to this; the step S4 may record positions of the plurality of grids divided into the plurality of regions and a number of grids in each of the plurality of regions to obtain a region information, but not limited to this; the step S4 may multiply at least one current exposure time by the corresponding at least one compensation ratio to generate the at least one compensated exposure time, but not limited to this.

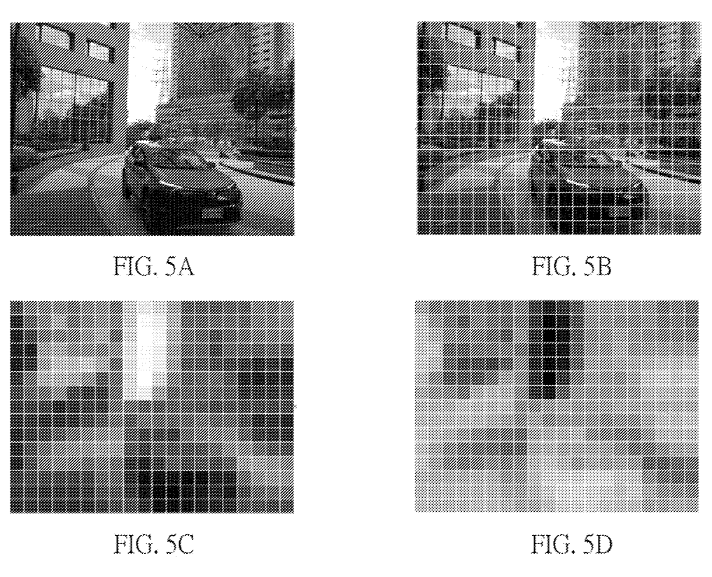

Please refer to FIGS. 5A to 5D. In the step S1, a preview color image is first obtained in the preview mode (as shown in FIG. 5A), and then the preview color image is converted into a preview grayscale image and divided into a plurality of grids (as shown in FIG. 5B); in the step S2, the preview grayscale image is downscaled (for example, from 256 levels to 8 levels) to obtain a downscaled preview grayscale image (as shown in FIG. 5C); in the step S3, an inverse compensation is performed, after subtracting the maximum value from each level in the second level and taking the absolute value, the inverse compensation is performed on the downscaled preview grayscale image to obtain an inverse-compensated downscaled preview grayscale image (as shown in FIG. 5D).

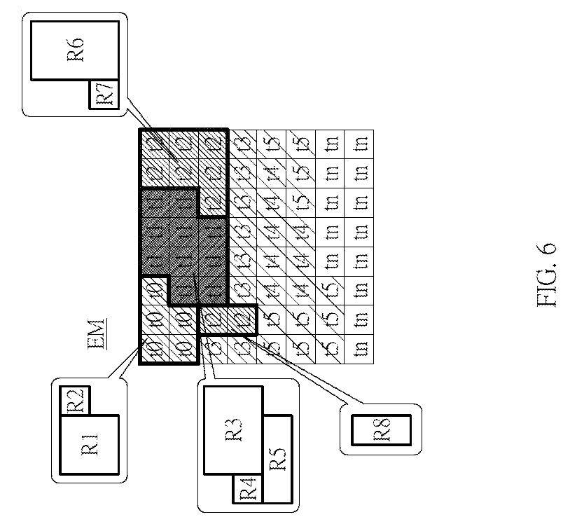

Please refer to FIG. 6. FIG. 6 is a schematic diagram showing an embodiment of an exposure image EM and region information. Assuming that the grayscale is (n+1) grayscale from the 0th level to the nth level, the step S4 may respectively multiply the current exposure time of the 0th level to the nth level by a compensation ratio to obtain the compensated exposure time t0 of the 0th level to the compensated exposure time tn of the nth level. All grids of the exposure map EM are filled with corresponding compensation exposure times (e.g., t0) according to which level (e.g., the 0th level) the average gray level belongs to from the 0th level to the nth level.

Next, the step S4 may declare a plurality of regions R1~R8 and divide the plurality of grids into corresponding regions in the plurality of regions R1~R8, and record the positions of the plurality of grids divided into the plurality of regions R1~R8 and the number of grids in each region in the plurality of regions R1~R8 to obtain the region information. In fact, the plurality of regions R1~R8 are all rectangular regions and each region R1~R8 includes one or more grids.

For example, there are 5 grids corresponding to the 0th level (its compensated exposure time is t0), 4 grids of the 5 grids are divided into the region R1 and the other grid of the 5 grids is divided into the region R2; there are 10 grids corresponding to the first level (its compensated exposure time is t1), 6 grids of the 10 grids are divided into the region R3, 1 grid of the 10 grids is divided into the region R4 and another 3 grids of the 10 grids are divided into the region R5; there are 9 grids corresponding to the second level (its compensated exposure time is t2), 6 grids of the 9 grids are divided into the region R6, 1 grid of the 9 grids is divided into the region R7 and 2 grids of the 9 grids are divided into the region R8, and the region R8 is separated from the regions R6 and R7 and the region R8 is not connected to the regions R6 and R7; as for the other grids corresponding to the third level (its compensated exposure time is t3) to the nth level (its compensated exposure time is tn), the same can be said and will not be described in detail here.

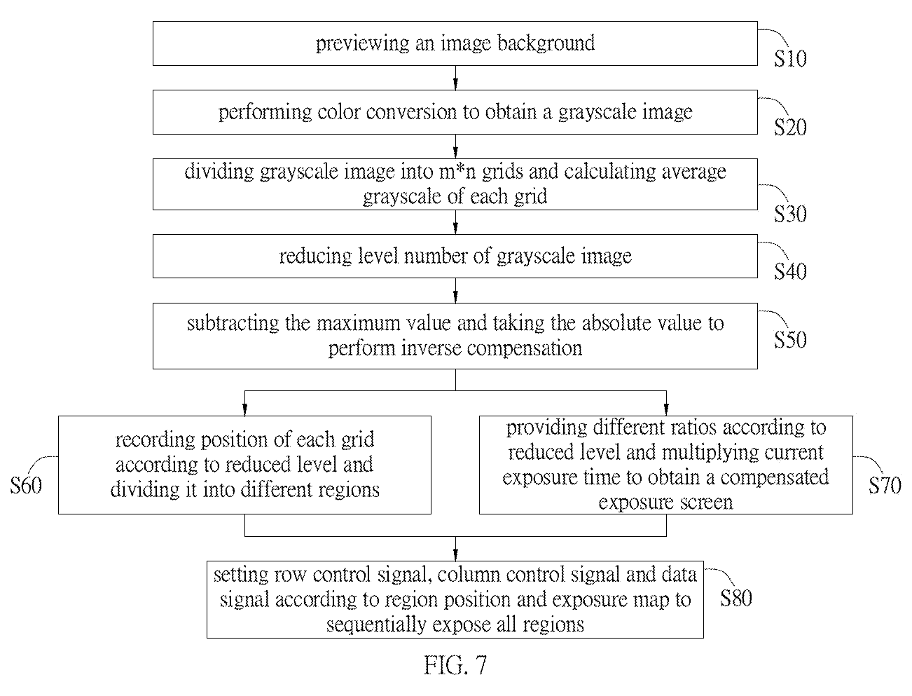

Please refer to FIG. 7. FIG. 7 is a flow chart of an image processing method according to another embodiment of the present disclosure. As shown in FIG. 7, the image processing method may include the following steps:

S10: previewing an image background;

S20: performing color conversion to obtain a grayscale image;

S30: dividing the grayscale image into m*n grids and calculating an average grayscale of each grid;

S40: reducing the level number of the grayscale image;

S50: subtracting the maximum value and taking the absolute value to perform inverse compensation;

S60: recording the position of each grid according to the reduced level and dividing it into different regions;

S70: providing different ratios according to the reduced level and multiplying the current exposure time to obtain a compensated exposure image; and

S80: setting a row control signal, a column control signal and a data signal according to the region position and the exposure map to sequentially expose all regions.

In actual applications, before the user presses a shooting button of the camera, the step S10 may obtain a preview color image as shown in FIG. 5A in a preview mode with a lower resolution (e.g., 1080P). Next, the step S20 may use the commonly used color space conversion formula (Gray = 0.299*R + 0.587*G + 0.114*B) to convert the preview color image shown in FIG. 5A into a preview grayscale image as shown in FIG. 5B, and then the step S30 may divide the preview grayscale image as shown in FIG. 5B into m*n grids and calculate the average grayscale of each grid.

Assuming that the data range of the preview grayscale image as shown in FIG. 5B is from level 0 to level 255 (a total of 256 levels), in order to reduce the amount of image processing calculations, the step S40 may divide the level of the preview grayscale image as shown in FIG. 5B by a preset ratio (e.g., 32) to reduce it from 256 levels (8 bits) to 8 levels (3 bits), so that similar grayscales are compatible with each other and their data range is reduced to level 0~level 7 (a total of 8 levels), so as to obtain a downscaled preview grayscale image as shown in FIG. 5C. It should be noted that although the above-mentioned downscaling process can reduce the amount of image processing calculations, it also sacrifices some details in the preview grayscale image. Therefore, the designer needs to consider both at the same time to achieve a balance.

Then, the step S50 may perform an inverse compensation on the downscaled preview grayscale image shown in FIG. 5C. For example, by obtaining the exposure compensation amount by subtracting the highest-level value from the input value and taking the absolute value to obtain the output value (Output=Abs[Input-LV(max)]). Thus, the darkest (underexposed) grayscale 0th level in the image can correspond to the highest exposure compensation amount LV(7), while the brightest (overexposed) grayscale 255th level in the image can correspond to the lowest exposure compensation amount LV(0).

Next, the step S70 may provide appropriate compensation ratios for the eight levels of the exposure compensation amounts LV(0) to LV(7) according to the current exposure time. For example, the compensation ratio of the exposure compensation amount LV(0) is 0.80, the compensation ratio of the exposure compensation amount LV(1) is 0.85, the compensation ratio of the exposure compensation amount LV(2) is 0.88, ..., and the compensation ratio of the exposure compensation amount LV(7) is 1.25. Assuming that the automatic exposure algorithm of the processor looks up the exposure table according to the camera's incoming light for the current scene and obtains the current exposure time required to achieve the target brightness is 33 ms, then the compensated exposure time t0 required for the grid corresponding to the exposure compensation amount LV(0) is 33ms*0.80=26.4ms, the compensated exposure time t1 required for the grid corresponding to the exposure compensation amount LV(1) is 33ms*0.85=28.05ms, the compensated exposure time t2 required for the grid corresponding to the exposure compensation amount LV(2) is 33ms*0.88=29.04ms, ..., the compensated exposure time t7 required for the grid corresponding to the exposure compensation amount LV(7) is 33ms*1.25=41.25ms, and so on, the final exposure map can be obtained by analogy.

As for the step S60, a plurality of regions (such as R1~R8 shown in FIG. 6) may be declared and a double-loop (m*n) scanning method may be used to divide grids corresponding to the same compensated exposure time (exposure compensation amount) into the same region and record their positions and the number of grids in each region. It should be noted that the plurality of regions are all rectangles containing one or more grids. For non-rectangular regions, they can be divided into multiple rectangular regions and set in batches. Therefore, the region information obtained in the step S60 includes a plurality of regions and the grid position information in each region.

For example, there are 5 grids corresponding to the compensation exposure time t0. Since the shape of the region is not rectangular, 4 grids of the 5 grids are divided into a rectangular region R1 and the other grid of the 5 grids is divided into a rectangular region R2. There are 10 grids corresponding to the compensation exposure time t1. Since the shape of the region is not rectangular, 6 grids of the 10 grids are divided into a rectangular region R3, 1 grid of the 10 grids is divided into a rectangular region R4, and the other 3 grids of the 10 grids are divided into a rectangular region R5. There are 9 grids corresponding to the compensation exposure time t2, 6 grids of the 9 grids are divided into a rectangular region R6, 1 grid of the 9 grids is divided into a rectangular region R7, and 2 grids of the 9 grids are divided into a rectangular region R8. The region R8 is separated from the regions R6 and R7 and the region R8 is not connected to the regions R6 and R7; as for the other grids corresponding to the compensation exposure times t3~tn, the same can be said and will not be repeated here.

It should be noted that there is no specific restriction on the execution order of the above-mentioned steps S60 and S70. The steps S60 and S70 may be executed simultaneously, the step S60 may be executed first and then the step S70 is executed, or the step S70 may be executed first and then the step S60 is executed, depending on actual needs.

Finally, the step S80 may set a column control signal X-BUS, a row control signal Y-BUS and a data signal DAT for each region according to the region information obtained in the step S60 and the exposure map obtained in the step S70 to start exposure for each region, and outputs the exposed region to the memory. After the entire frame is exposed, it can be outputted to the processor.

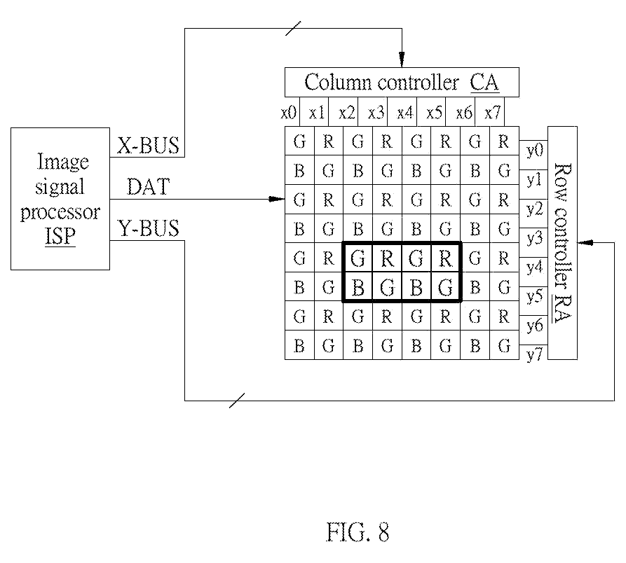

Please refer to FIG. 8. FIG. 8 is a schematic diagram showing how the image signal processor ISP of the present disclosure controls a specific region for exposure through the column control signal X-BUS, the row control signal Y-BUS and the data signal DAT. As shown in FIG. 8, the image signal processor ISP is coupled to a column controller CA and the row controller RA respectively and provides the column control signal X-BUS and the row control signal Y-BUS to the column controller CA and the row controller RA respectively. The column controller CA outputs the 0th column signal x0~the 7th column signal x7 to the 0th column grid~ the 7th column grid according to the column control signal X-BUS, and the row controller RA outputs the 0th row signal y0~the 7th row signal y7 to the 0th row grid~ the 7th row grid according to the row control signal Y-BUS, so as to independently control whether each grid is exposed.

For example, the image signal processor ISP may provide the column control signal X-BUS to control the second column signal x2~the fifth column signal x5 outputted by the column controller CA to be 1 and provide the row control signal Y-BUS to control the fourth row signal y4~the fifth row signal y5 outputted by the row controller RA to be 1, so as to control the grid located at the second column and fourth row, the grid located at the second column and fifth row, the grid located at the third column and fourth row, the grid located at the third column and fifth row, the grid located at the fourth column and fourth row, the grid located at the fourth column and fifth row, the grid located at the fifth column and fourth row and the grid located at the fifth column and fifth row in the thick line enlargement region for exposure, but not limited to this.

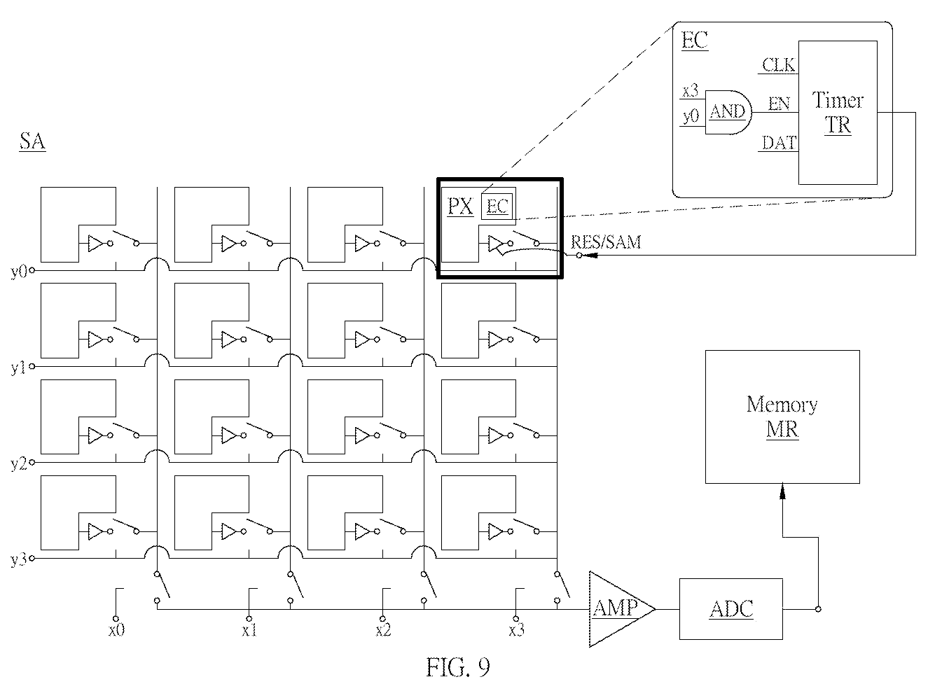

Please refer to FIG. 9. FIG. 9 is a schematic diagram of a CMOS image sensor array of the present disclosure. As shown in FIG. 9, the CMOS image sensor array SA includes a plurality of pixels PX and each pixel PX has an independent exposure control circuit EC, which can receive a control signal and exposure data transmitted by a front-end image signal processor ISP to independently perform exposure.

The exposure control circuit EC may include an AND gate AND and a timer TR coupled to each other. Taking the pixel PX in the third column and 0th row as an example, when the column signal x3 and the row signal y0 received by the two input terminals of the AND gate AND are both high-level, the output terminal of the AND gate AND will output a high-level enable signal EN to the timer TR. The timer TR receives the clock signal CLK, the data signal DAT and the enable signal EN respectively and outputs a reset signal RES or a sampling signal SAM to the output terminal of the pixel PX. The data signal DAT includes the compensated exposure time corresponding to the pixel PX. When the enable signal EN is high-level, the timer TR is enabled to start timing and the pixel PX starts to be exposed at the same time. When the compensation exposure time corresponding to the pixel PX ends, the timer TR stops timing and the pixel PX stops being exposed at the same time. This action can be applied to all pixels in the region corresponding to the same compensation exposure time to complete exposure at the same time. For non-rectangular regions, they are divided into several rectangular regions and set them in batches. The output signals of all pixels PX of the CMOS image sensor array SA are amplified by the output amplifier AMP and then converted into digital output signals by the analog-to-digital converter ADC and stored in the memory MR. In practical applications, the timer TR can also be any up-count or down-count counter, but not limited to this.

In summary, the image processing method and device proposed in the present disclosure adopts a single frame HDR technology using "pixel-based exposure", the same exposure time may be used to expose multiple grids with similar grayscale and divided into the same region. Not only can multiple different exposure time lengths exist in a single frame to obtain an HDR image that simultaneously preserves the bright and dark details in a single frame, but there is no need to obtain multiple frames with different exposure time lengths for image synthesis, so that the complexity and workload of the entire image processing process can be greatly reduced.

The contents disclosed above are merely feasible embodiments of the present disclosure, and are not intended to limit the scope of the claims of the present disclosure. Therefore, all equivalent technical changes made based on the specification and the drawings of the present disclosure fall within the scope of the claims of the present disclosure.

What is claimed is:

1. An image processing method, comprising:
in a preview mode, dividing a preview grayscale image into a plurality of grids and obtaining average grayscales of the plurality of grids respectively;
performing an inverse compensation on the preview grayscale image;
declaring a plurality of regions and dividing the plurality of grids into corresponding regions among the plurality of regions to generate a region information, and generating an exposure map including at least one compensated exposure time based on at least one current exposure time and at least one compensation ratio; and
in a shooting mode, exposing using the at least one compensated exposure time to obtain an image based on the region information and the exposure map.

2. The image processing method according to claim 1, further comprising:
downscaling the preview grayscale image and performing the inverse compensation on the downscaled preview grayscale image.

3. The image processing method according to claim 1, further comprising:
dividing a first level of the preview grayscale image by a preset ratio to downscale the first level to a second level.

4. The image processing method according to claim 3, wherein the inverse compensation comprising:
for each level in the second level, subtracting the maximum value and taking the absolute value, thereby generating a plurality of exposure compensation amounts corresponding to the second level, so that the highest level in the second level corresponds to the lowest exposure compensation amount, and the lowest level in the second level corresponds to the highest exposure compensation amount.

5. The image processing method according to claim 1, further comprising:
recording positions of the plurality of grids divided into the plurality of regions and a number of grids in each of the plurality of regions to obtain the region information.

6. The image processing method according to claim 1, further comprising:
multiplying the at least one current exposure time by the corresponding at least one compensation ratio to generate the at least one compensated exposure time.

7. The image processing method according to claim 3, further comprising:
in response to a specific compensation exposure time of the at least one compensation exposure time corresponding to a specific level of the second level, exposing all grids in at least one region of the plurality of regions corresponding to the specific level with the specific compensation exposure time.

8. The image processing method according to claim 1, further comprising:
in response to one of the plurality of regions being a non-rectangular region, dividing the region into a plurality of rectangles and set in batches.

9. An image processing device, comprising:
a processor, configured to:
in a preview mode, divide a preview grayscale image into a plurality of grids and obtain average grayscales of the plurality of grids respectively;
perform an inverse compensation on the preview grayscale image;
declare a plurality of regions and divide the plurality of grids into corresponding regions among the plurality of regions to generate a region information, and generate an exposure map including at least one compensated exposure time based on at least one current exposure time and at least one compensation ratio; and
generate a row control signal, a column control signal and a data signal according to the region information and the exposure map; and
an image sensor array, coupled to the processor, and is configured to expose using the at least one compensated exposure time in a shooting mode to obtain an image based on the row control signal, the column control signal and the data signal.

10. The image processing device according to claim 9, wherein the processor is further configured to downscale the preview grayscale image and perform the inverse compensation on the downscaled preview grayscale image.

11. The image processing device according to claim 9, wherein the processor is further configured to divide a first level of the preview grayscale image by a preset ratio to downscale to a second level.

12. The image processing device according to claim 11, wherein the processor is configured to perform the inverse compensation, which comprises:
for each level in the second level, the processor is configured to subtract the maximum value and take the absolute value, thereby generating a plurality of exposure compensation amounts corresponding to the second level, so that the highest level in the second level corresponds to the lowest exposure compensation amount, and the lowest level in the second level corresponds to the highest exposure compensation amount.

13. The image processing device according to claim 9, wherein the processor is further configured to record positions of the plurality of grids divided into the plurality of regions and a number of grids in each of the plurality of regions to obtain the region information.

14. The image processing device according to claim 9, wherein the processor is further configured to multiply the at least one current exposure time by the corresponding at least one compensation ratio to generate the at least one compensated exposure time.

15. The image processing device according to claim 11, wherein a specific compensation exposure time of the at least one compensation exposure time corresponds to a specific level of the second level, the image sensor array is configured to expose all grids in at least one region of the plurality of regions corresponding to the specific level with the specific compensation exposure time.

16. The image processing device according to claim 9, wherein in response to one of the plurality of regions declared by the processor being a non-rectangular region, the processor is further configured to divide the region into a plurality of rectangles and set in batches.

17. The image processing device according to claim 9, wherein the image sensor array comprises a plurality of pixels, and each of the plurality of pixels has an independent exposure control circuit.

18. The image processing device according to claim 17, wherein the exposure control circuit comprises:
a logic component configured to receive the row control signal and the column control signal and output an enable signal; and
a counter coupled to the logic component and configured to start counting according to the enable signal until the compensation exposure time ends.

19. The image processing device according to claim 18, wherein in response to both the row control signal and the column control signal being at a first level, the logic component outputs the enable signal at the first level to enable the counter to start counting, and the pixel to start being exposed simultaneously, until the compensation exposure time ends, the counter stops counting and the pixel stops being exposed simultaneously.

20. The image processing device according to claim 18, wherein the counter is configured to receive a clock signal and the data signal and obtain the compensation exposure time from the data signal, and the counter is a timer and the logic component is an AND gate component.
